(19) United States
(12) Patent Application Publication
(10) Pub. No.: US 2021/0175796 A1
(43) Pub. Date: Jun. 10, 2021

(54) Voltage Stabilizer

(71) Applicant: Mosway Semiconductor LTD, N.T. (CN)

(72) Inventors: Ka Wai Ho, Diamond Hill (CN); Chung Pui Tung, Kennedy Town (CN); Po Wa Chow, Shatin (CN); Wing To Fan, N.T. (CN); Wan Tim Chan, Yuen Long (CN); Ke Wei Wang, Tai Po (CN); Shu Hung Henry Chung, Mid-levels (CN); Chiu Sing Celement Tse, Yuen Long (CN)

(21) Appl. No.: 16/705,709

(22) Filed: Dec. 6, 2019

(51) Int. Cl. H02M 1/42; H02M 3/158; G05F 1/56

(52) U.S. Cl. CPC H02M 1/4225; G05F 1/56; H02M 3/1582

(57) ABSTRACT

Disclosed herein is a fast voltage stabilizer wherein an actual voltage across a targeted electronic element is sensed. The actual voltage is compared with a reference voltage. A control signal is generated, wherein in response to the control signal, an external current path is provided to maintain current flow and stabilize the actual voltage through charging or discharging an input capacitor and a supply filtering capacitor. Under an arbitrary supply voltage variation, a fast dynamic response to regulate the voltage across the targeted electronic element is provided no matter what the operating mode of the entire electrical circuit is, including but not limited by constant current mode, constant output resistant mode and constant power mode.

### BACKGROUND

This disclosure relates to a voltage stabilizer and, more particularly, to a fast voltage stabilizer configured to minimize voltage fluctuation.

A flyback power factor corrector (PFC) has been widely used in low-power applications. Its basic structure consists of a diode bridge for initial ac-dc rectification and a flyback dc-dc converter for shaping the waveform of the input current in phase with the supply voltage. As the input current of the flyback dc-dc converter is pulsating, an input filter is required to prevent the unwanted pulsating current from getting into the ac supply. Many research efforts have been emphasized on the structure, modeling, and design optimization of the input filter (for example, see “C. Tung et al., “Flyback PFC With a Series-Pass Module in Cascode Structure for Input Current Shaping” in IEEE Transactions on Power Electronics, vol. 34, no. 6, pp. 5362-5377, June 2019 [“Tung”]” [the entirety of which is herein incorporated by reference]).

The input filter in a power electronic system is used to prevent unwanted switching harmonics, radiated or conducted noise, generated by the switching network, from getting into the source. It is typically made up of passive elements. A large body of the literature has been devoted to design, analyze, and package input and output filters for different power electronic systems by modeling, experimentation, and simulation. For example, the input filter of the power factor preregulator is used to perform line filtering and electromagnetic interference (EMI) filtering.

At least one investigation into the use of series-pass device (SPD) to filter out input current harmonics of switching converters has been performed (for example, see “W. Fan, K. K. Yuen and H. S. Chung, “Power Semiconductor Filter: Use of Series-Pass Device in Switching Converters for Filtering Input Current Harmonics” in IEEE Transactions on Power Electronics, vol. 31, no. 3, pp. 2053-2068, March 2016 [“Fan”]” [the entirety of which is herein incorporated by reference]). This idea is based on connecting a SPD in series with the input of the switching converter so that the input current of the entire system can be profiled by adjusting the biasing condition of the SPD. To minimize the power dissipation of the SPD, the input impedance of the switching converter is controlled to make the SPD operate at the boundary between the linear and saturation modes.

Accordingly, there is a need for providing a fast dynamic response to regulate the voltage across targeted electronic elements.

### SUMMARY

In accordance with one aspect of the disclosure, a fast voltage stabilizer is described where under an arbitrary supply voltage variation, a fast dynamic response to regulate the voltage across a targeted electronic element can be provided no matter what the operating mode of the entire electrical circuit is, including but not limited by constant current mode, constant output resistant mode and constant power mode.

In accordance with another aspect of the disclosure, a fast voltage stabilizer wherein an actual voltage across a targeted electronic element is sensed is disclosed. The actual voltage is compared with a reference voltage. A control signal is generated, wherein in response to the control signal, an external current path is provided to maintain current flow and stabilize the actual voltage through charging or discharging an input capacitor and a supply filtering capacitor.

### BRIEF DESCRIPTION OF THE DRAWINGS

The foregoing aspects and other features various exemplary embodiments of the invention are explained in the following description, taken in connection with the accompanying drawings, wherein:

FIG. 1 is a schematic of an electronic circuit connecting to a source through a series pass device;

FIG. 2(a) is a plot illustrating key waveforms of the electronic circuit connecting with series pass device (sudden increase in the supply voltage vₛ.);

FIG. 2(b) is a plot illustrating key waveforms of the electronic circuit connecting with series pass device (sudden decrease in the supply voltage vₛ.);

FIG. 3(a) is a schematic of an electronic circuit connecting with series pass device and voltage stabilizer (connecting across SPD with a low-voltage stabilizer);

FIG. 3(b) is a schematic of an electronic circuit connecting with series pass device and voltage stabilizer (connecting across input capacitor with a high-voltage stabilizer);

FIG. 4(a) is a schematic of an implementation of a fast voltage stabilizer (linear-mode voltage stabilizer);

FIG. 4(b) is a schematic of an implementation of a fast voltage stabilizer (switching-mode voltage stabilizer);

FIG. 5(a) is a schematic illustrating integration of the power converter with fast voltage stabilization function (connecting the SPD to the power converter with bidirectional power flow);

FIG. 5(b) is a plot illustrating integration of the power converter with fast voltage stabilization function (key waveforms);

FIG. 6(a) is a schematic illustrating a power factor corrector using boost-type DC/DC converter (connecting an SPD [MOSFET] and the boost PFC);

FIG. 6(b) is a plot illustrating a power factor corrector using boost-type DC/DC converter (key waveforms);

FIG. 7(a) is a schematic illustrating a power factor corrector (connecting the SPD and the bidirectional boost PFC that can perform fast voltage stabilization on v_{T});

FIG. 7(b) is a plot illustrating a power factor corrector (key waveforms);

FIG. 8 is a schematic illustrating a switching network incorporating features of the disclosure;

FIG. 9(a) is a schematic illustration of introducing bidirectional power flow function into converter (Buck converter);

FIG. 9(b) is a schematic illustration of introducing bidirectional power flow function into converter (Buck Boost converter);

FIG. 9(c) is a schematic illustration of introducing bidirectional power flow function into converter (single-ended primary-inductor converter [SEPIC]);

FIG. 9(d) is a schematic illustration of introducing bidirectional power flow function into converter (Zeta converter);

FIG. 10(a) is a plot illustrating key voltage and current waveforms (Theoretical waveforms);

FIG. 10(b) is a plot illustrating key voltage and current waveforms (Zoomed waveforms of operating mode transition between two modes);

FIG. 11 is a plot illustrating three waveforms (zoomed during the transition between the buck and boost modes);

FIGS. 12(a)-12(b) are plots of a Transient Response with the Load Switched between 50% to 100% of the rated load (Timebase: 40 ms/div); and

FIGS. 13(a)-13(b) are plots of Steady-state waveforms (Timebase: 4 ms/div).

### DETAILED DESCRIPTION

Current control circuit is widely used to control the flow of electric charge in electric networks. An ideal current source can maintain its current independent on the voltage across it and has an infinite output impedance across it. It is preferably implemented by connecting a voltage source connected in series with a linear-type series-pass device (SPD) because linear-type SPD generally provides fast dynamic response, small output ripple current, and low output noise. Such SPD is used to control the value of the output current of the voltage source. Nevertheless, in order to minimize its power dissipation, it is preferably to have low voltage drop across the SPD.

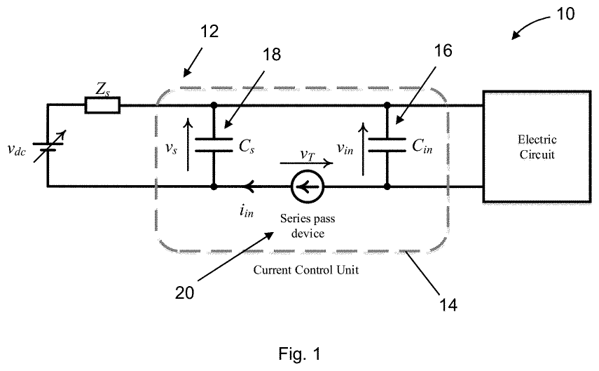

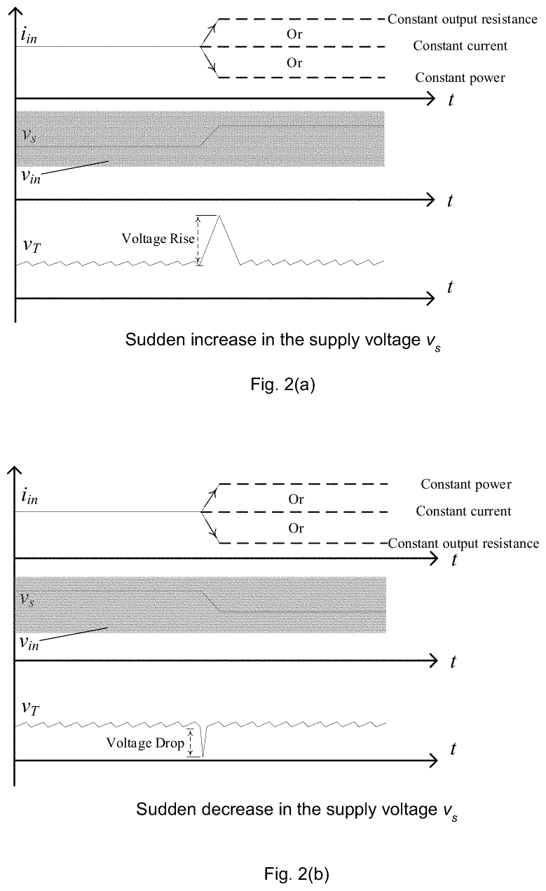

FIG. 1 shows an electronic circuit 10 connecting to a source vₛ (12) through a current control unit 14. It consists of an input capacitor Cᵢₙ (16), a supply filtering capacitor Cₛ (18), and an SPD 20 that controls the profile of the input current, iᵢₙ. The key waveforms of the electronic circuit are shown in FIG. 2. When there is a sudden change of the supply voltage, vₛ, a large fluctuation of the voltage across the SPD appears. FIG. 2(a) illustrates such an increase in vₛ. Cᵢₙ will be charged up by vₛ through partial current of iᵢₙ. However, within such time interval, iᵢₙ is well regulated under constant power operation, constant output resistance operation or constant current operation, but not limited by those operation. The trend and level of vᵢₙ cannot respond to the change of vₛ swiftly. Therefore, the voltage difference between vₛ and vᵢₙ will be applied across the SPD. FIG. 2(b) shows the waveform of the decrease in vₛ. Similarly, Cᵢₙ will be discharged by vₛ through the partial current of iᵢₙ. The trend and level of vᵢₙ could not respond to the change of vₛ. Therefore, a voltage drop is observed on v_{T}. To conclude the effect, the voltage fluctuation on v_{T} is caused by the regulated input current iᵢₙ and the variation of the supply voltage vₛ. No matter if there is a voltage change on vₛ or not, the voltage v_{T} has to withstand a desired level eventually.

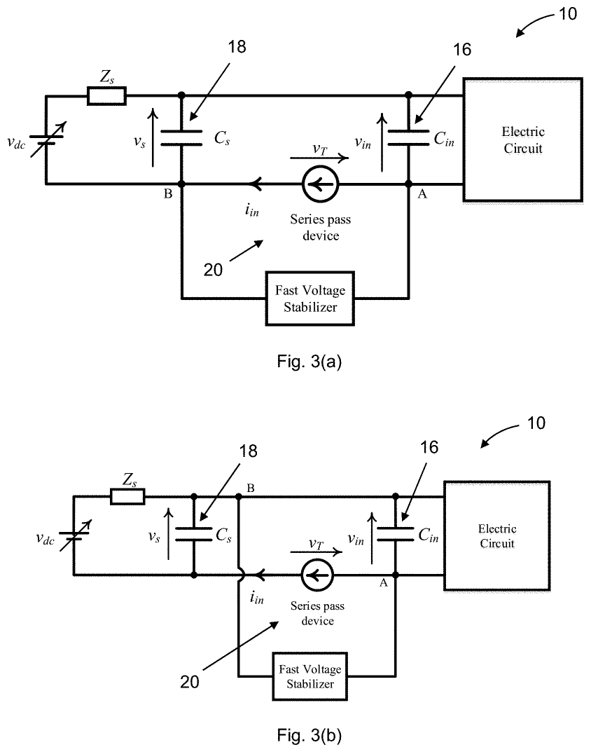

The present invention proposes a current regulation structure with a fast voltage stabilizer to minimize the voltage fluctuation on the SPD. As shown in FIGS. 3(a), 3(b), the structure comprises a current control unit and a fast voltage stabilizer. FIG. 3(a) is a low voltage stabilizer connecting across the SPD 20. FIG. 3(b) is a high voltage stabilizer connecting across Cᵢₙ (16). The current control unit, which is implemented by a low-voltage device, is used to profile the current through the SPD with wide frequency bandwidth. The voltage stabilizer is used to stabilize the voltage across the SPD.

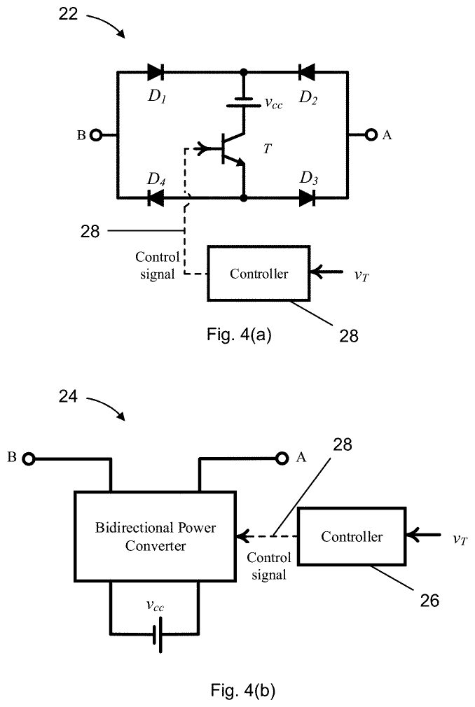

FIGS. 4(a), 4(b) exemplify implementations of the voltage stabilizer. It consists of energy sources or energy buffers to provide an external current path to maintain the current flow through the current regulator and also stabilize the voltage v_{T} through charging or discharging Cᵢₙ and Cₛ swiftly. FIG. 4(a) shows a bidirectional linear-mode voltage stabilizer 22. FIG. 4(b) shows a bidirectional switching-mode voltage stabilizer 24. They are controlled by a controller (or processor) 26, which senses the actual voltage of the current regulator v_{T}, compares with a reference voltage V_{ref}, and generates the control signal 28.

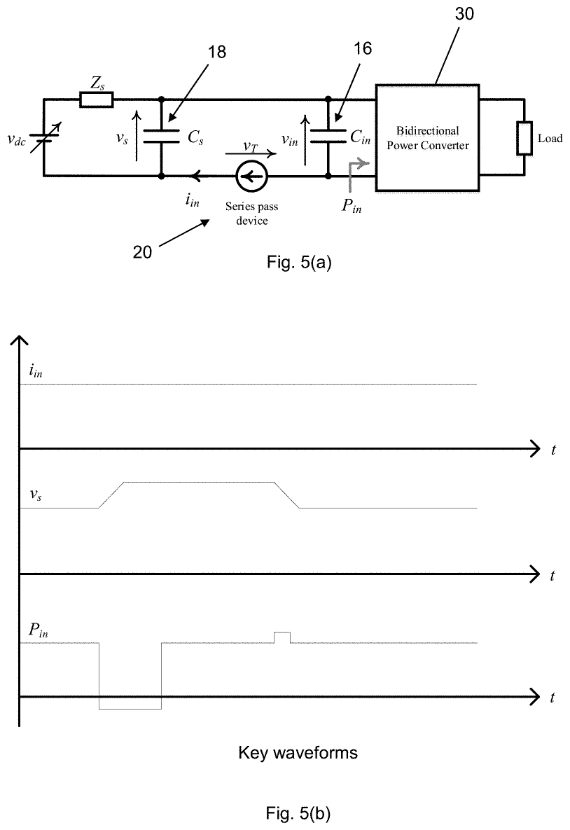

It should be noted that the voltage stabilizer allows bidirectional power flow and has fast response to regulate the voltage across the SPD under the variation of the supply voltage. In some applications, such as power factor correctors and DC-DC power supplies connecting with DC microgrid, the electric circuit connecting between the current regulator and the load is typically a power converter. If the power converter has bidirectional power flow control and fast dynamic response, the function of the fast voltage stabilizer can also be performed by the power converter. FIG. 5(a) shows the connection between the SPD 20 and the power converter 30 with bidirectional power flow serving as fast voltage stabilizer. FIG. 5(b) shows the waveforms of the input power flow of the power converter under a sudden change of the supply voltage. The current can be regulated in any profile under arbitrary supply voltage, not limited to constant current, depending on the design criteria.

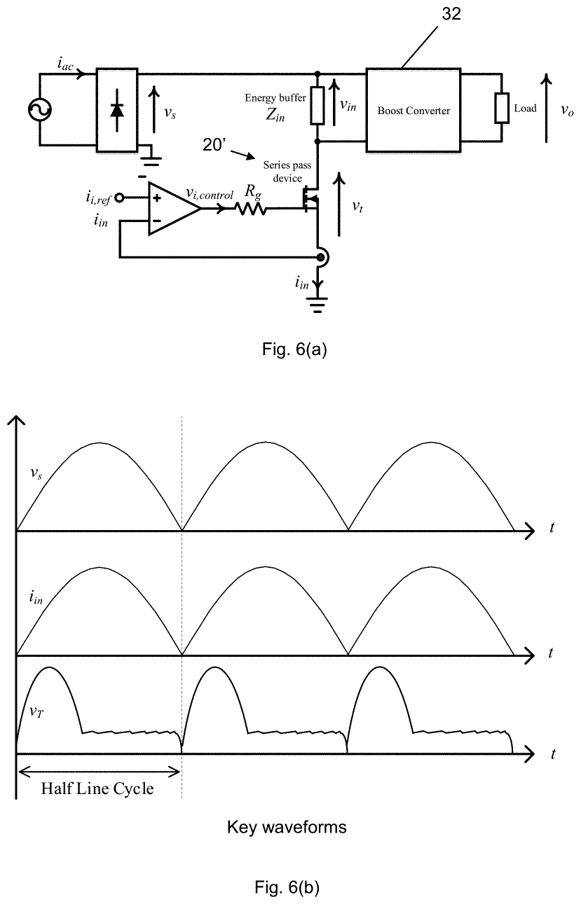

According to one exemplary embodiment, the proposed structure is verified by applying it to control the input current waveform of a power factor corrector using a boost DC/DC converter. The circuit is shown in FIG. 6(a), in which a series pass device (SPD) 20′ is connected in series with the input of the boost converter 32. The voltage across the SPD 20′ is regulated at a low level by changing the duty cycle of the main switch in the boost DC/DC converter 32. By adjusting the control signal to the SPD 20′, the input current of the power factor corrector (PFC) is profiled to be in phase with the supply voltage and regulate the output voltage. The current through the SPD 20′ is sensed by a sensor and will be compared with the current reference I_{in,ref}. The key waveforms around the zero-crossings of each line cycle are shown in FIG. 6(b). At the starting point of each half grid line cycle, the energy buffer Zᵢₙ, which is typically a capacitor but not limited to other types of storage element, will be charged up by vₛ, following iᵢₙ. However, as the output current of the full-bridge diode rectifier in the PFC varies from zero to the peak value, the input capacitor will be charged up slowly around the zero-crossings. A high voltage on the SPD will appear after the start of a half line cycle. Its magnitude and duration depend on the magnitude of the input current. Thus, a high-voltage device for the SPD is needed. However, high-voltage devices have large channel length modulation effect, high leakage current, large voltage drop, and slow response. To alleviate this issue, Tung has proposed a series pass module (SPM), constructed by a cascode structure with two series-connected devices. One of them is a high-voltage device of low on-state resistance for sharing major voltage stress, while the other one is a low-voltage device with high output impedance for profiling the current through the SPM. Such configuration is more suitable for low-power applications. As shown in FIGS. 6 and 18 (of Tung), the SPM has voltage stress of higher than 100V in the normal operation. The voltage stress increases as the load reduces and the supply voltage increases. This will introduce extra power loss on the SPM which will lower the power conversion efficiency.

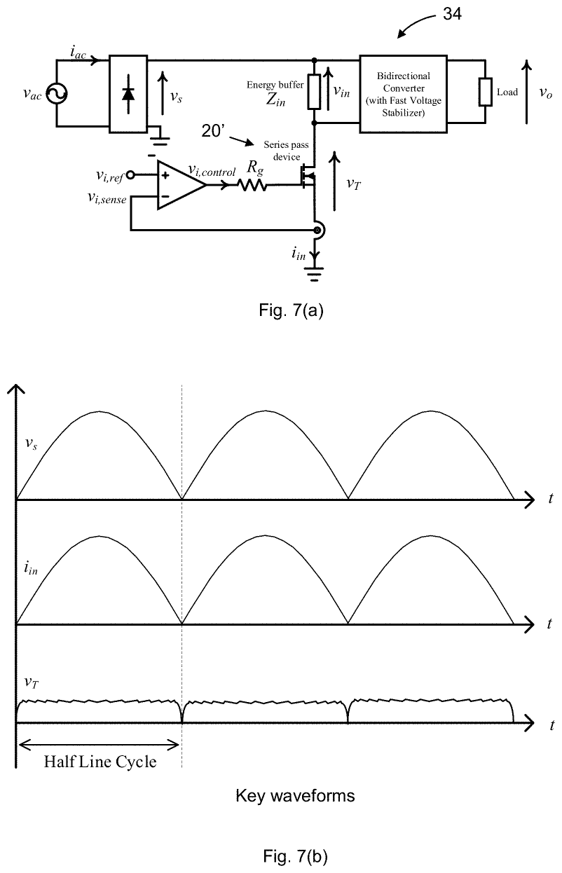

Therefore, various exemplary embodiments of the invention are designed and placed into the PFC to replace the previous approach. FIG. 7(a) shows an example of PFC with the proposed invention. The power conversion stage (PCS) 34 is not limited to boost converter, and can be of different types. The voltage across the invented structure, v_{T}, is shown as the waveform in FIG. 7(b). There is no large voltage fluctuation at the beginning of every half line cycle throughout any loading condition within the specified operating supply voltage range. Therefore, the input current iᵢₙ can be still regulated and the SPD 20′ still operates under low voltage stress.

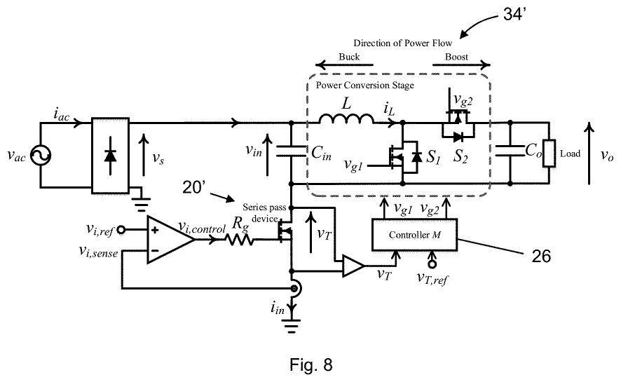

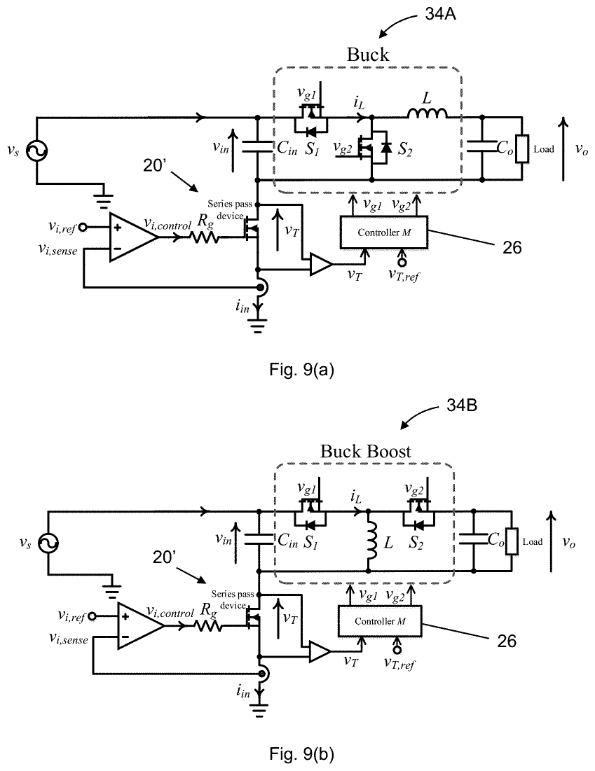

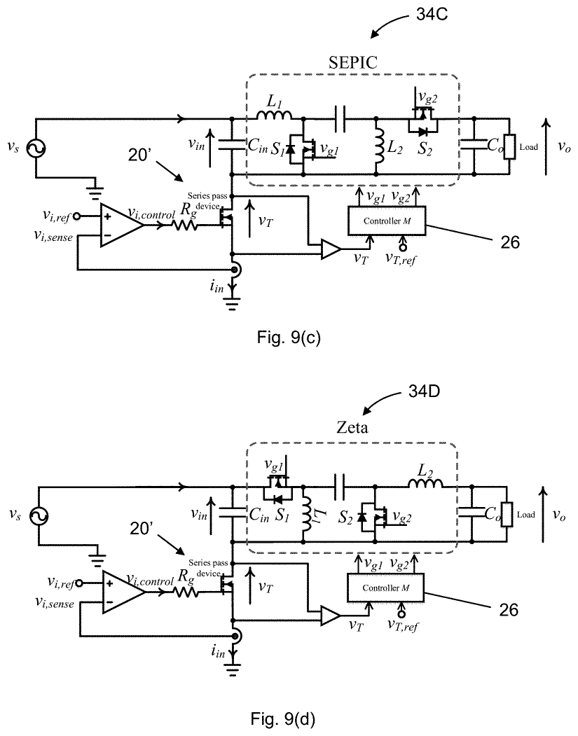

As shown in FIG. 8, an exemplary embodiment of the present invention is illustrated by introducing bidirectional power flow function into the conventional boost converter (PCS 34′). The technique is based on replacing the output switching diode with an active switch. Some examples are shown in FIGS. 9(a)-9(d), in which buck, buck-boost, SEPIC (single-ended primary-inductor converter), and Zeta converters (34A, 34B, 34C, 34D) are introduced with bidirectional power flow function.

While SPD is regulating the current flowing through itself according to the control signal v_{i,control}, the voltage across the SPD v_{T} is retrieved as an information for Controller M (26). Controller M (26) is treated as the control system of Fast Voltage Stabilizer as mentioned above. The function of M is to manipulate the operation of PCS so that the voltage across the input energy buffer of PCS is regulated to maintain a desired level of v_{T}, that is, v_{T,ref}.

In this implementation, a switching network is applied to realize the idea. According to FIG. 8, the Controller M (26) gives the switching information v_{g1} and v_{g2} for the active switches S₁ and S₂ to regulate the power flow between Cᵢₙ and Cₒ.

A. Boost Mode

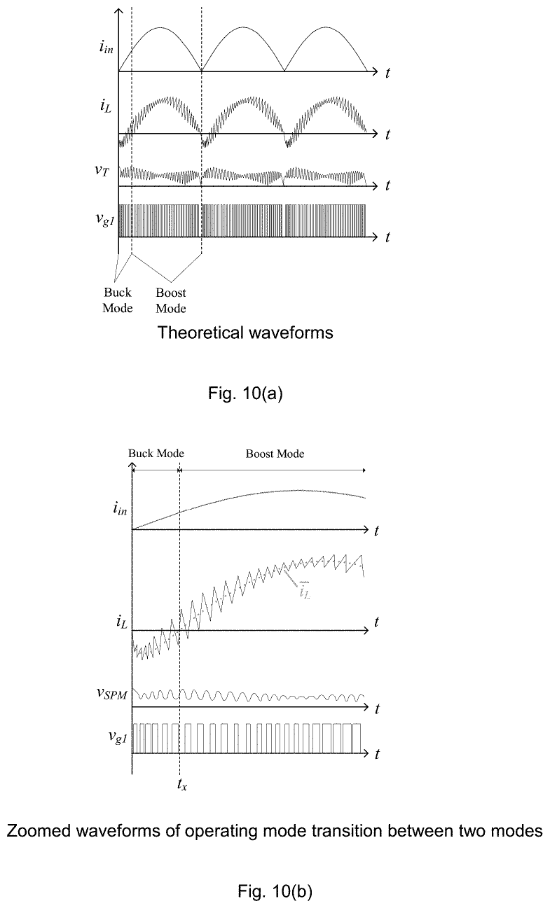

The operation of this mode is similar to a boost converter operation and is briefly described below (where FIGS. 10(a), 10(b) show theoretical predictions of this implementation). The waveforms are shown in FIG. 10(a). The input current iᵢₙ is profiled in the same wave shape as vₛ according to the control signal v_{i,control}. The voltage across the SPD v_{T} is regulated at v_{T,ref} by the Controller M.

The input current iᵢₙ is sensed and processed with v_{i,ref} to generate the signal v_{i,control} to control the current flowing through SPD.

At the same time, v_{T} is sensed and processed with v_{T,ref} by the Controller M. Thus, it derives the gate signals for the switches S₁ and S₂. If v_{T}>v_{T,ref}, the duty cycle of S₁ will decrease and that of S₂ will increase, and vice versa. Typically, v_{T,ref} is set at 1V to minimize the power loss of SPD, but not limited to any voltage level.

iᵢₙ starts from zero in every half cycle of the mains voltage. If the PCS purely operates in boost mode, S₁ is turned off by the Controller M to charge up Cᵢₙ by iᵢₙ and thus reduce v_{T}. As discussed in Tung, the voltage across SPD, v_{T}(t), is

$${v}_{T} ( t ) = {V}_{s , P e a k} sin ω t - \frac{{I}_{in , Peak}}{ω {C}_{in}} ( 1 - cos ( ωt ) \qquad ( 1 )$$

The voltage across the SPM is maximum at t_{VT,Peak} and the peak value is V_{T,Peak}. It can be shown that

$$\begin{matrix}{t}_{VT , Peak} = \frac{1}{ω} {tan}^{1} ( \frac{{V}_{s , Peak} {C}_{in}}{{I}_{in , Peak}} ) \\ and & ( 2 ) \\ {V}_{T , Peak} = {V}_{s , Peak} sin [ {tan}^{- 1} ( \frac{{V}_{s , Peak} {C}_{in}}{{I}_{in , Peak}} ) ] - \frac{{I}_{in , Peak}}{ω {C}_{in}} \{ 1 - cos [ {tan}^{- 1} ( \frac{{V}_{s , Peak} {C}_{in}}{{I}_{in , Peak}} ) ] \} & ( 3 )\end{matrix}$$

Thus, t_{VT,Peak} and V_{T,Peak} increase as I_{in,Peak} decreases. To reduce V_{T,Peak}, Cᵢₙ is charged up by the output capacitor with the converter operated as a buck converter. The operation is described below.

B. Buck Mode

Apart from maintaining the output voltage, the output capacitor is also used to charge up Cᵢₙ, so that the input voltage vᵢₙ follows the profile of vₛ. The average value of i_{L}, ī_{L,av}, is

$$\begin{matrix}{\overline{{i}_{L}}}_{, av} ( t ) = {i}_{in} ( t ) - {i}_{cin} ( t ) \\ = {I}_{in , Peak} sin ω t - \frac{d }{dt} ( {C}_{in} {V}_{s , Peak} sin ω t ) , \\ = {I}_{in , Peak} sin ω t - ω {C}_{in} {V}_{s , Peak} cos ω t\end{matrix} \qquad ( 4 )$$

for ω t ϵ[0, π],
where i_{cin}(t) is the current through Cᵢₙ.

As shown in FIG. 10(b), i_{L} is negative at the start of each half line cycle to charge up Cᵢₙ. It will become positive at tₓ. It can be shown that

$${t}_{ϰ} = \frac{1}{ω} {tan}^{- 1} \frac{ω {C}_{in} {V}_{s , Peak}}{{I}_{in , Peak}} \qquad ( 5 )$$

Hence, this mode starts at t=0 and ends at t=tₓ.

Starting from the zero-crossing point, iᵢₙ will increase and will thus accelerate charging of Cᵢₙ when vₒ reduces, and then reverts to the boost mode.

Finally, as derived in Fan, the ideal efficiency of the system η is

$$η = 1 - \frac{{V}_{SPM , ref}}{{V}_{s , r m s}} \qquad ( 6 )$$

where V_{s,rms} is the rms value of the rectified supply voltage vₛ.

Since the voltage across the SPD determines the energy efficiency, it is thus advantageous to use low-voltage devices, which have small channel length modulation effect, low leakage current, low voltage drop, and fast response.

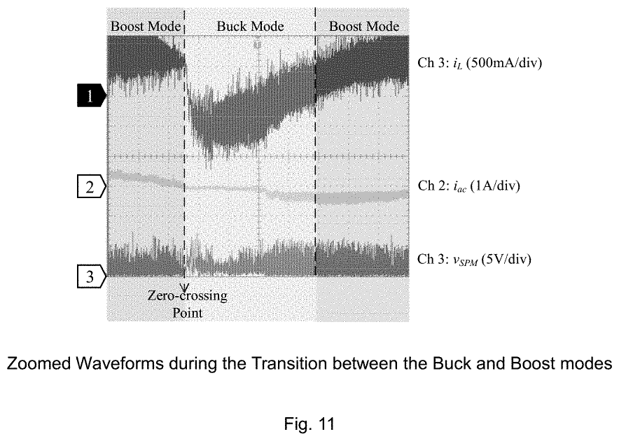

FIG. 11 shows the waveforms of i_{L}, i_{ac}, and v_{SPM} around a zero crossing, switching between buck and boost modes. The supply voltage is 220 Vrms and the load is very light, at 5% of the rated power. i_{ac} is small, less than 0.5 A. The inductor current i_{L} becomes negative after the zero-crossing region and the PCS is switched into the buck mode. After i_{L} has become positive, the PCS is switched back into the boost mode. v_{SPM} is kept around 1V over the transition period. The waveforms are in close agreement with that in FIG. 10(b).

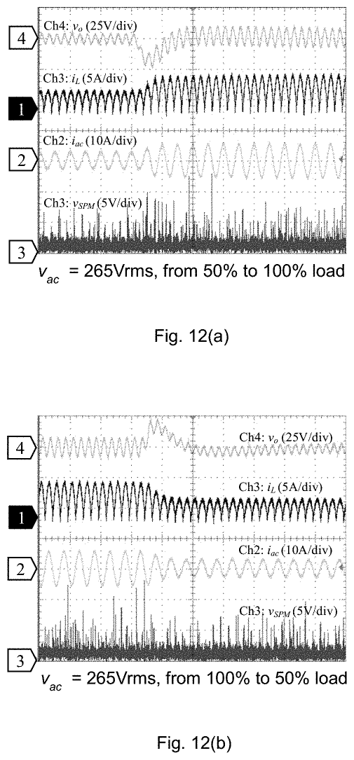

FIGS. 12(a)-(b) show the transient responses of the PFC when the load is switched between 50% and 100% of the rated load and the supply voltage is 85 Vrms and 265 Vrms, respectively. Results reveal that the PSF is capable of maintaining the power factor correction function during the transient and the voltage across the SPD can also be kept small.

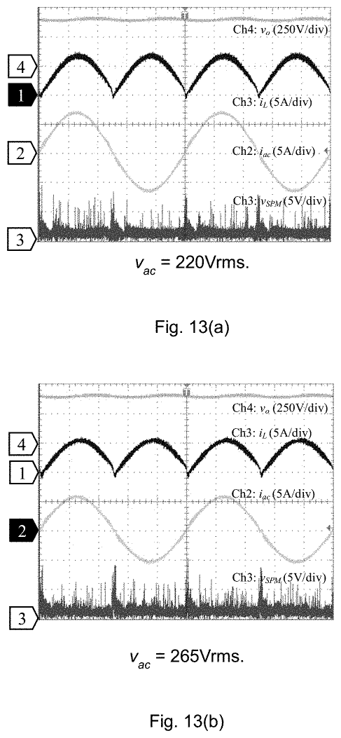

FIG. 13(a)-(b) show that the phase and wave shape of the line current i_{ac} are the same as the supply voltage v_{ac}. The proposed prototype is operating under full load condition with v_{ac} equal to 220 Vrms and 265 Vrms, respectively. The average value of the voltage across the SPD, i.e., v_{T}, is around 1V and the peak value is less than 10V over a half-life cycle.

Thus, low-voltage devices with low channel length modulation effect and low effective saturation voltage can be chosen for this high-voltage application. This confirms the function of the idea of exemplary embodiments of the invention is capable to remove high-voltage stress across SPD appears around the zero crossings. Take the previous work in Tung as an example, the flyback PFC prototype in Tung has a SPM in cascode structure constructed by connecting a high-voltage device in series with a low-voltage device. Experimental results show that the voltage stress on the SPM is higher than 100V (FIGS. 6 and 18 in Tung). Comparing with Tung, the proposed technique can effectively reduce the voltage stress across the SPM. Low-voltage devices for the SPD can thus be used.

According to various exemplary embodiments, the controller (or processor) 26 may comprise a microprocessor coupled to a memory, such as on a printed circuit board for example. The memory could include multiple memories including removable memory modules for example.

It should be understood that components of the invention can be operationally coupled or connected and that any number or combination of intervening elements can exist (including no intervening elements). The connections can be direct or indirect and additionally there can merely be a functional relationship between components.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

1. An apparatus comprising:
a controller; and
at least one memory having stored therein machine-readable instructions;
the at least one memory and the machine-readable code configured to, with the at least one controller, cause the apparatus to perform at least the following:
sense an actual voltage;
compare the actual voltage with a reference voltage; and
generate a control signal, wherein in response to the control signal, an external current path is provided to maintain current flow and stabilize the actual voltage through charging or discharging an input capacitor and a supply filtering capacitor.

2. The apparatus of claim 1, wherein the actual voltage is a voltage across a targeted electronic element.

3. The apparatus of claim 1, wherein the actual voltage is a voltage across a series pass device (SPD).

4. The apparatus of claim 1 wherein the control signal is sent from the controller to a transistor.

5. The apparatus of claim 1 wherein the apparatus comprises a bidirectional linear-mode voltage stabilizer.

6. The apparatus of claim 1 wherein the control signal is sent from the controller to a bidirectional power converter.

7. The apparatus of claim 1 wherein the apparatus comprises a bidirectional switching-mode voltage stabilizer.

8. The apparatus of claim 1 wherein the apparatus comprises a voltage stabilizer, wherein the voltage stabilizer is configured to provide, under an arbitrary supply voltage variation, a dynamic response to regulate the voltage across a targeted electronic element regardless of the operating mode of the entire electrical circuit, including constant current mode, constant output resistant mode and constant power mode.

9. A method comprising:
sensing an actual voltage;
comparing the actual voltage with a reference voltage; and
generating a control signal, wherein in response to the control signal, an external current path is provided to maintain current flow and stabilize the actual voltage through charging or discharging an input capacitor and a supply filtering capacitor.

10. The method of claim 9, wherein the actual voltage is a voltage across a targeted electronic element.

11. The method of claim 9, wherein the actual voltage is a voltage across a series pass device (SPD).

12. The method of claim 9, further comprising sending the control signal from a controller to a transistor of a bidirectional linear-mode voltage stabilizer.

13. The method of claim 12, wherein the bidirectional linear-mode voltage stabilizer is configured to provide, under an arbitrary supply voltage variation, a dynamic response to regulate the voltage across a targeted electronic element regardless of the operating mode of the entire electrical circuit, including constant current mode, constant output resistant mode and constant power mode.

14. The method of claim 9, further comprising sending the control signal from a controller to a bidirectional power converter of a bidirectional switching-mode voltage stabilizer.

15. The method of claim 14, wherein the bidirectional switching-mode voltage stabilizer is configured to provide, under an arbitrary supply voltage variation, a dynamic response to regulate the voltage across a targeted electronic element regardless of the operating mode of the entire electrical circuit, including constant current mode, constant output resistant mode and constant power mode.

16. A non-transitory computer-readable storage media storing computer-executable instructions, the instructions when executed on a processor cause the processor to:
sense an actual voltage across a targeted electronic element or a series pass device (SPD);
compare the actual voltage with a reference voltage; and
generate a control signal, wherein in response to the control signal, an external current path is provided to maintain current flow and stabilize the actual voltage through charging or discharging an input capacitor and a supply filtering capacitor.

17. The non-transitory computer-readable storage media of claim 16, wherein the instructions when executed on the processor further cause the processor to send the control signal to a transistor of a bidirectional linear-mode voltage stabilizer.

18. The non-transitory computer-readable storage media of claim 17, wherein the bidirectional linear-mode voltage stabilizer is configured to provide, under an arbitrary supply voltage variation, a dynamic response to regulate the voltage across a targeted electronic element regardless of the operating mode of the entire electrical circuit, including constant current mode, constant output resistant mode and constant power mode.

19. The non-transitory computer-readable storage media of claim 16, wherein the instructions when executed on the processor further cause the processor to send the control signal to a bidirectional power converter of a bidirectional switching-mode voltage stabilizer.

20. The non-transitory computer-readable storage media of claim 19, wherein the bidirectional switching-mode voltage stabilizer is configured to provide, under an arbitrary supply voltage variation, a dynamic response to regulate the voltage across a targeted electronic element regardless of the operating mode of the entire electrical circuit, including constant current mode, constant output resistant mode and constant power mode.
